(19) United States
(12) Patent Application Publication
(10) Pub. No.: US 2018/0015515 A1
(43) Pub. Date: Jan. 18, 2018

(54) A NOVEL METHOD AND AN APPARATUS IN CONVERTING UNSORTED MUNICIPAL SOLID WASTE INTO GEO-POLYMER PELLETS/BRIQUETTES AND GEO-POLYMER BRICKS/PAVER BLOCKS

(71) Applicant: NEWAY MSW IP HOLDING LLP, T Nagar, Chennai (IN)

(72) Inventor: S K Sivakumar, Mudichur (IN)

(73) Assignee: NEWAY MSW IP HOLDING LLP, T Nagar, Chennai (IN)

(21) Appl. No.: 15/548,471

(22) PCT Filed: Feb. 12, 2016
(86) PCT No.: PCT/IN2016/000041

§ 371 Date: Aug. 3, 2017

(30) Foreign Application Priority Data
Feb. 12, 2015 (IN) 389/CHE/2015

(51) Int. Cl. B09B 3/00; C10B 57/10; C10B 57/02; C10B 53/07; C10B 47/22; B02C 19/00; B02C 4/08; B07B 9/00; B07B 1/22; B03C 1/23; B02C 21/00; F26B 11/02; C10B 5/00

(52) U.S. Cl. CPC B09B 3/0083; F26B 11/028; C10B 57/10; C10B 57/02; C10B 53/07; C10B 47/22; C10B 5/00; B02C 4/08; B07B 9/00; B07B 1/22; B03C 1/23; B09B 3/0041; B02C 21/00; B02C 19/005; B02C 2201/06

(57) ABSTRACT

Apparatus and method in converting municipal solid waste into geo-polymer briquettes and geo-polymer bricks comprising bag opener cum crushers, magnetic separators for ferrous and-eddy current separators for non-ferrous things; squeezer for removing liquid content; inter particle collision driers for drying; pulverizer for pulverizing, and devolatizing carbonization reactor for carbonisation of combustible MSW to produce solid char with low water content. Solid char is mixed with geo-polymer binding agent/starch/tar/to form combustible pellet/briquette. These highly combustible briquette/pellets have high calorific value. The pellet/briquette is formed by rotating combustible char at high rpm and compaction. Pellet has a water content of less than 5% by weight and fuel value of 5500 to 6500 KCAL. This process produces non-combustible geo-polymer brick. The non-combustible MSW separated by a trommel is crushed by inter particle collision crusher and pan mixers mixing with geo-polymer binding agent/fly ash/quarry dust/chips or china clay and moulded.

This invention relates to using an innovative set of equipment, machines and processes as an apparatus for converting municipal solid waste into geo-polymer briquettes and geo-polymer bricks applying a novel technology.

### BACKGROUND OF THE INVENTION

Municipal Solid Waste Management (MSWM) is major responsibility of local government. Daily generation of solid wastes is a fact of life in industrialized society and their disposal is becoming an ever-increasing problem. The more common of these waste materials is. Municipal Solid Waste (MSW). MSW is defined to include refuse from households, non-hazardous solid waste from industrial, commercial and institutional establishments (including hospitals), market waste, yard waste and street sweepings. Historically rivers have been fouled with waste, swamps have been filled, and air polluted by waste being burned in open pits. Governmental agencies have become increasingly aware of the cumulative effects of these activities in recent years. They began to mandate controls for the disposal of waste. Land filling was the primary method of waste disposal, which became very ineffective. When poorly contained landfills decompose, hazardous materials may find their way into the environment. After land filling, the land becomes useless for 30 years.

Therefore land filling has inherent problems such as unavailability of land, degeneration of ground water, pollution, incineration produces pollutants causing respiratory diseases. Incomplete combustion of MSW causes pollutants.

The most commonly considered alternative to the landfill method is mass incineration. Incineration produce a variety of pollutants, which if improperly regulated or in high concentrations may cause respiratory discomfort and disease.

These pollutants are believed to be caused by incomplete combustion of municipal solid waste and the combustion of plastic.

The disposal of solid wastes has become an increasingly severe problem in view of the increasing population, the concentration of populations in urban and suburban areas and in the increasing number of industries generating solid wastes. A large fraction of such waste may be of organic origin which is of a combustible nature. This organic fraction is normally made up of such materials as paper, textiles, leather, rubber, yard wastes, wood, wood wastes and bark, garbage and some forms of plastics. However, such an organic fraction requires processing to make it suitable as a fuel. In addition, solid wastes generally contain an inorganic fraction which may comprise ferrous and nonferrous metals as well as glass, dirt, and other forms of plastics.

Inasmuch as it is becoming increasingly difficult to dispose of solid wastes by such previously known means as dumping and filling, a critical need has arisen to find other techniques for solid waste disposal, such techniques of necessity being those which do not create pollution problems and those which do not require the expenditure of appreciable amounts of energy. Moreover, if the end product or products of the disposal process are themselves usable, the process is even more desirable.

In general, the techniques more recently proposed for solid waste disposal may be classified as those which provide apparatus for bulk reduction, conversion or reclamation. Although some advances in bulk reduction (densification) have been made, each of those techniques used (baling, incineration, etc.) have inherent drawbacks including disposal of the densified material, pollution control, and the like.

Conversion is generally defined as the chemical or biochemical transformation of the waste material into a useful product. The techniques used therein include Pyrolysis (destructive distillation or decomposition at elevated temperatures, e.g., 400° C. to 870° C. in the absence of air or other reactive or oxidizing gases), partial oxidation, composting (aerobic conversion of cellulose waste into inert humus-like material by aerobic bacteria), hydrogenation, wet oxidation, hydrolysis, anaerobic digestion, biological fractionation and the like.

Reclamation involves the separating out by hand sorting of materials such as glass, plastics, metals, papers, textiles and the like for reuse in one form or another. However, other than some forms of paper (corrugated and newsprint), some plastics and textiles, the combustible component of organic solid wastes have not been recovered. Only recently some serious attempt was made to convert these combustible materials to a form in which they could be used as a fuel. In addition to the lack of effectiveness, many people dislike the inconvenience of separating garbage, removing labels and lids, washing cans, bundling newspapers and other aspects of curbside recycling. In addition to the vast expense incurred in collecting recyclable curbside, money also must be spent on educating the public to use curbside recycling for it to be effective. Recycling has also been considered to be the most desirable way of dealing with ever growing menace caused by MSW.

However there has not so far been any technology that does recycling completely. Moreover educating the masses to segregate MSW into bio-degradable and non-degradable waste is a major problem and the problem is intense when it comes to the masses living in under developed countries. People generally dislike the inconvenience of separating garbage, removing labels and lids, washing cans, bundling newspapers and other aspects of curbside recycling, in addition to costs associated with educating the public to use curbside recycling in order to be effective.

Thus there is a need to process MSW with minimal sorting, without the need to spend funds to educate the public on its use, without the creation of harmful pollutants without mass burning, without land filling and in aviable exploitable and scalable way.

### PRIOR ART

1. U.S. Pat. No. 8,560,459B2 describes about Methods and facilities for a municipal solid waste management system wherein the invention includes a system and method for creating a municipal solid waste (MSW) system to address the multiple types of waste that are disposed by the public, and further, provides effective screening and separation of hazardous components in the waste stream, and further provides recovery and reuse solutions as alternatives to disposal of hazardous waste. The invention further provides communities with a system and method to more effectively capture and use disposed MSW and other waste streams to provide renewable energy sources. Moreover, the present invention includes a method for establishing a municipal solid waste management system that makes sustainable development possible while preserving the economic interests of the parties involved. Accordingly, the US patent describes about an improvement in the art of landfill design and waste management that will accomplish the twin goals of a zero-emissions facility and the development of usable, renewable resources for the community. In short, what is needed is an approach to MSW management.

The invention is about a system for and method of designing and operating a synergistically connected, sustainable environmental and economic development program to manage solid waste. The invention is specifically adapted to operate in a zero-emissions state while simultaneously providing numerous assets that will aid in community development and economic growth. Utilization of the system and method of the invention yields larger landfill space through novel use of recycling, degradation, containment and energy extraction sub-systems. In part, the invention includes a synergistic system comprised of various landfill elements such as a municipal recycling facility, an electronic recycling facility, an environmental education center, a landfill gas energy production plant, a waste to energy biomass production plant, a beneficiating facility for glass, plastics and pulp, and means for composting and renewable energy production. The landfill gas energy production plant stores and distributes gas removed from the landfill that can be used for energy. The system utilizes its own conversion means to harness the landfill gas energy for operating the various landfill elements, including the vacuum or other means that remove the gas in the first place. Moreover, the landfill gas can be distributed to the community for use by other industries that consume methane and other chemicals for energy use, including heating uses. Each of these elements is selected and synergistically utilized,to meet the unique needs of each community.

2. U.S. Pat. No. 6,397,492 B1 describes about the Apparatus and method for processing municipal solid waste, into useful products, and for reducing biohazards and putrid odors derived from MSW. The MSW is loaded into an elongated, generally cylindrically shaped rotating pressure vessel and is subjected to heat and pressure by the application of steam in specified amounts to break down the organic portion of the MSW into a cellulose feedstock, or a de-manufactured paper product, of uniform particle size and density. This product is then easily separable from other constituents of MSW, such as glass, aluminum and other metals, and plastics. The recyclables are recovered and sold in the market. The waste water from the process is reduced by processing through a water vamping apparatus. The apparatus and process disclosed allows for an economically and technically viable industrial process and environmental solution, which have the potential to replace current landfill technology. The apparatus is comprised of a cylindrical vessel, containing at least one steam line for introducing steam into the interior of the vessel, and at least one valve for selectively releasing steam and/or pressure from the vessel during the process. The vessel further includes doors or hatches, or similar means to access the interior of the vessel for loading and unloading MSW. (The MSW may actually be transported to the vessel by a conveyor or other traditional means.) The apparatus includes a means for rotating the vessel, such as the use of trunnion rings and rollers, or chain-driven gear and sprocket system or “spud” ring. Any stable method of rotating the vessel at a controlled speed would be suitable. The interior of the vessel includes a structure for agitating the MSW as the vessel is rotated, such as a conical flighting or similar ridged or paddle-like structure. The apparatus further includes a boiler or other steam source for producing steam with which to heat and pressurize the vessel, and conventional steam lines, valves, and gauges for transporting, controlling, and measuring the flow of steam, temperature, and pressure. Optionally, the apparatus may include a water vamping apparatus, operatively connected to the release valve on the vessel, for evaporating and condensing the process discharge.

The process is summarized as follows. The vessel is preheated prior to loading to a predetermined preheating temperature. During loading, steam is fed into the vessel to maintain temperature, and the door at the far end of the vessel is shut during the loading process. After the vessel is loaded with MSW, the door through which the MSW was loaded is shut, steam is introduced continually into the vessel, and the vessel becomes pressurized. Fresh steam is continuously fed into the chamber from the loading end, and after a predetermined processing pressure is reached, steam is allowed to escape the chamber from the far end into the discharge steam line. The temperature and pressure of the vessel are monitored, and the flow of steam is regulated to keep the process within predetermined processing ranges (around 50 psi, 150° C.). The vessel is rotated at a predetermined speed (depending on the size of the vessel), and after a predetermined amount of time (20 to 45 minutes), the pressure is released and the processed MSW is removed.

3. EP 2257510 A1 describes about a Method and apparatus for converting waste materials into fuels and other useful products. Conversion of waste and other organic feedstock into sustainable energy, feed, fertilizer, and other useful products of reliable purities is accomplished using water, heat, and pressure. More specifically, the invention provides methods and apparatus that handle mixed streams of various feedstock, e.g. agricultural waste, biological waste, municipal solid waste, municipal sewage sludge, and shredder residue, to yield gas, oil, specialty chemicals, and carbon solids that can be used as is or are further processed. Useful products can be diverted at various points of the process or internalized to enhance the efficiency of the system. This invention describes about a method and apparatus for generating sustainable energy, fuel, feed, fertilizer, specialty chemicals, and other useful products, from low value or waste feed streams. In some embodiments, a method involves preparing a slurry from a feedstock; heating the slurry at least to a first temperature under a first pressure to form a composition comprising an inorganic material, a liquid organic material, and water; separating the inorganic material, the liquid organic material, and water; and heating the liquid organic material to a second temperature higher than the first temperature under a second pressure higher than the first pressure to yield at least one product selected from the following: a fuel, a feed, a fertilizer, or a specialty chemical. In further embodiments, the method may comprise depolymerizing the slurry followed by hydrolyzing certain products of the depolymerization. Methods and apparatus for treatment of waste materials are also provided by the invention. In some embodiments, the feedstock includes agricultural waste. In other embodiments, the feedstock includes municipal solid waste. In still other embodiments, the feedstock includes municipal sewage sludge. In yet other embodiments, the feedstock includes shredder residue.

4. U.S. Pat. No. 4,152,119 A describes about Briquette comprising caking coal and municipal solid waste. Briquettes of specified geometry and composition are produced to serve as feed material or “burden” in a moving-burden gasifier for the production of a synthesis or fuel gas from organic solid waste materials and coal, including especially, the so-called “caking” coals. The briquettes are formed from a well-blended mixture of shredded organic solid wastes, including especially, municipal solid waste (MSW) or biomass, and crushed caking coal, including coal fines. A binder material may or may not be required, depending on the coal/MSW ratio and the compaction pressure employed. The briquettes may be extruded, stamped, or pressed, employing compaction pressures in excess of 1000 psi, and preferably in the range of 2000 to 10,000 psi. The briquettes may be circular, polygonal, or irregular in cross-section; they may be solid, or concentrically perforated to form a hollow cylinder or polygon; they may be formed into saddles, pillows or doughnuts. The ratio of caking coal to shredded municipal solid waste is controlled so that each part of the predominately cellulosic organic solid waste will be blended with 0.5 to 3.0 parts of crushed coal. Suitable binder materials include dewatered sewage sludge (DSS), “black liquor” rich in lignin derivatives, black strap molasses, waste oil, and starch. The binder concentration is preferably in the range of 2 to 6 percent. If coals high in sulfur content are to be processed, at least a stoichiometric equivalent of dolomite may be included in the briquette formulation to eliminate a major fraction of the sulfur with the slag. One of the aspects of the invention is directed to an improvement in the Simplex Process for the simultaneous gasification of coal and organic solid waste materials. The improvement comprises using in said process the feed material or burden in the form of novel discrete compacted articles of manufacture, e.g., briquettes, of specified composition and geometry, as hereinafter described. The term briquette is intended to cover the compacted articles of the invention regardless of their shape, whether solid or with a hole therein, and regardless of the method of compacting. These articles of manufacture or briquettes are further characterized by having a minimum acceptable standard of structural integrity, for example, at least sufficient to preserve their cohesive strength until they have gravitated through the Drying and Pyrolysis zones to the High Temperature Reaction and Partial Combustion zones in the Simplex Process. The desired structural integrity may be achieved partly through the use of high compaction pressures and partly through the use of suitable binder materials incorporated in the feed mixture. The use of binders is optional, but preferred.

The organic solid waste material is preferably rich in cellulosic matter, such as waste paper in MSW, or wood waste and plant stalks in agricultural refuse. Such agricultural waste can be high in pentosan content, e.g., corn cobs, oat hulls, and plant stalks, or high in lignocellulose, e.g., wood waste. Desirably, the organic solid waste contains at least 50% of the cellulosic material. The MSW is normally comminuted in a shredder or hammer mill; it may then be processed for the recovery of ferromagnetic metals by passing over a magnetic separator or it may be air-classified to separate a light combustible organic fraction from a heavy, noncombustible inorganic fraction comprising predominantly glass and metals. The present invention is therefore particularly directed to the preparation of novel shaped articles of manufacture comprising a substantial or preponderant quantity of caking coal plus waste, preferably with a binder. The shape of the extrusions, briquettes, or pellets may be circular or polygonal (either regular or irregular) in cross-section, and may vary in diameter from 1″ to 12″. Briquettes of similar size may be stamped or pressed in the form of saddles, pillows, hollow cylinders or doughnuts, for example. It has been found that a compaction pressure in excess of 1000 psi in forming the shaped article will give good results. Preferably the pressure is in the range of 2000 to 10,000 psi. When employing an extrusion device, it is desirable to equip it with a gate or chopper that will permit the alternation of compaction and extrusion cycles of the ram or augur, so as to permit control of the requisite compaction pressure. MSW normally contains 25 to 30% moisture derived in part from food waste and garden clippings. Upon compacting said materials, the expressed juices may impart binder properties to the mixture, especially if high compaction pressures are employed. However, it is generally preferable to employ specifically selected binders as additives to enhance the structural strength of the dried and pyrolyzied pellets for effective processing in the lower gasification zones of the shaft furnace. Such binders are particularly desirable if they also constitute a pollution-free disposal means for a troublesome waste product such as dewatered sewage sludge (DSS), or waste streams of the paper industry, such as lignin black liquor, or sulfite waste liquor. The amount of binder can be 2 to 6% on a dry basis. It should be sufficient to allow the briquette to retain its structural integrity in the gravitating bed. The binder is particularly needed to compact coal fines at the higher coal/MSW ratios, unless otherwise indicated, all parts and percentages are by weight. The drying of green briquettes requires a considerable amount of residence time in the shaft furnace, depending on the size and geometry of the briquette. In general, it is advantageous to employ a briquette geometry that affords a short route for the diffusion of gases and steam. Thus, when used in the Simplex Process the green briquettes must retain their mechanic strength while permitting efficient drying in the Preheat and Drying zone of the converter. As stated previously, it has been found that these requirements may be met either by employing a sufficiently high compaction pressure without binder, or by incorporating a low-cost binder material in the formulation and employing a lower compaction pressure. The degree of comminution of the organic solid waste material also has a direct bearing on the structural strength of the briquette. In general, the more finely shredded, the greater will be the strength of the green or dried briquette.

5. “An Alternative Fuel/Energy Solution Recycling Waste to Energy by M/s.PEDCON”. The object and purpose of this system is to find Solution to the disposal of MSW and resolving landfill solutions. Major process includes that MSW is recycled & converted to fuel RDF (Refuse Derived Fuel) pellets, energy and by products. 90% of MSW is converted into recyclable materials such as:-fuel, metals (ferrous and non ferrous), sand and plastics. Further 25% MSW contains, metals (ferrous & non-ferrous), Glass, sand, gravel, HD plastics, Ash etc., Next it is a fact that 65% of MSW is combustible and is converted and is processed and converted into high quality RDF fuel pellets and 7% of MSW comprised of food scraps, leather and Non descriptive refuse and is taken to landfill. Also 3% is moisture that is evaporated with in the process. RDF fuel is of 10:1 volumetric ratio made from shredded fiber waste as compared with ordinary RDF. Heat value when dry 7500 to 8500 BTU/lb which is equivalent to 75% to 85% of calorific value of most of the coals used in thermal & cement plants. The process is nonpolluting due to removal of all pollution causing elements from the incoming waste and all exhaust gases are directed to PEDCON dry scrubber pollution control system. The process can be used effectively up to 200 Ton/day of MSW.

The Operation process is that Shredding of MSW and magnetic separation and removal of ferrous material is done. All shredded material is dried for effective separation and classification. High density plastics are separated via gravity method. Remaining material is segregated utilizing series of air separators and screens to categorize light combustibles and heavy Non combustible materials. The light combustible materials are compacted to form RDF fuel pellets and utilized as fuel for steam turbines which in turn produces electricity. Non-combustible such as metals, glass, sand, ceramics, heavy plastics and fly ash are washed to refine these products for acceptance in the industry for recycling. The washed water is treated and returned as boiler feed water

6. US Patent 20020184816 A1 Conversion of municipal solid waste to high fuel value.

Features and Claims
a) The invention in this US Patent '816 relates to the conversion of municipal solid waste (MSW) to a fuel with a high fuel value, relates to MSW pellet that has a high fuel value and to a process for producing the pellet.
b) In preferred embodiments of this US Patent '816, the pellet comprises at least one waste substance of higher fuel value, to increase the fuel value of the pellet formed from municipal solid waste.
c) In another embodiment of US Patent '816, pellet is in the form of compacted fluff.
d) In a further embodiment of US Patent '816, the municipal solid waste is free of recyclable materials, especially free of substances selected from the group consisting of glass, metals, plastics and paper.
e) In a still further embodiment of US Patent '816, the emissions released from combustion of the pellet are less than safe permissible limits
f) In another preferred embodiment of US Patent '816, the pellet on combustion at a temperature of 1150° C. in air has a bottom ash content of less than 10% by weight.
g) In further embodiments, water content of pellet is in the range of 1-7% by weight.
h) A further aspect of the invention of US Patent '816 is that it has a process for the forming of a combustible pellet from municipal solid wastes, comprising the steps of:
   a) removing solid hazardous waste from said municipal solid waste;
   b) subjecting the municipal solid waste so obtained to at least one step to separate recyclable products there from;
   c) subjecting the product of step (b) to a shredding,and a pulverizing step, to form a fluff with a water content of less than 10% by weight; and
   d) compacting the fluff to form a combustible pellet.

7. U.S. Pat. No. 8,393,558 B2-Mechanized separation and recovery system for solid waste.

This US patent describes the methods and systems for separating a mixed waste into a wet organic fraction, a dry organic fraction, and an inorganic fraction achieved by (i) comminuting mixed solid waste, (ii) fractionating comminuted stream by size to produce particle-sized waste streams, and (iii) processing one or more of the particle-sized waste streams using density separation to produce an intermediate wastes stream, and (iv) recovering a homogenous product from the intermediate waste stream. Embodiments relate to methods and systems for processing of mixed solid waste such as MSW into a wet organic fraction, a dry organic fraction, and an inorganic fraction. Efficient separation and recovery is achieved by
(i) comminuting the mixed solid waste,
(ii) fractionating the comminuted stream by size to produce two or more particle-sked waste streams,
(iii) processing one or more of the particle-sized waste streams using density separation to produce an intermediate waste stream, and
(iv) recovering a one or more products from the intermediate waste stream.

The steps of commnution, size separation, and density separation allow efficient separation and recovery of wet organics, dry organics, and inorganic material from highly variable and highly diverse solid waste streams.

8. US 20120017499 A1

US Patent '499:Torrefaction Systems and Methods Including Catalytic Oxidation and/or Reuse of Combustion Gases Directly in a Torrefaction Reactor, Cooler,and/orDryer/Preheater;

The invention is about torrefaction systems and methods for producing torrefied products from biomass. Exemplary embodiments include catalytic oxidation and/or reuse of the resultant combustion gases directly in a torrefaction reactor, a cooler, and/or a dryer/preheater.

Torrefaction of biomass may be generally described as a mild form of pyrolysis at temperatures typically ranging between 200 to 300 degrees Celsius. During a typical torrefaction process, the properties of the biomass may change to obtain a much better fuel quality for later combustion of the torrefied biomass for production of energy. With conventional torrefaction systems using conventional combustion, the inventor hereof has recognized two drawbacks or problems.

First, the resultant flue gases are too high in residual oxygen content to be used directly in either the reactor or the cooler of a torrefaction system.

Second, a suitable internally-produced inert gas stream is not available to be used in the cooler. This would also preclude integration of the reactor and cooler.

### DRAWBACKS IN THE PRIOR ART

None of the prior art systems or apparatus or method mentioned above could convert both combustible and non-combustible materials from MSW to useful end products. None of the prior art systems or apparatus or the method mentioned above could work or function in such a manner that the entire process as a whole from input to output works closely linked and integrated and seems to be happening in almost completely automated sequences.

None of the prior art systems or apparatus or method mentioned above could work or function such that the whole process forms end to end closed loop system, so as to make the output of one stage becomes input to next stage and chain goes till the end.

### OBJECTS OF THIS INVENTION

The principal object of this invention is to provide a method and an apparatus which would convert both combustible and non-combustible materials from MSW to useful end products such as fuel pellets/briquettes out of combustible MSW and bricks/pavers out of non combustibleinert materials.

Another object of this invention is to provide a method and an apparatus in converting all municipal solid waste into geo-polymer pellets/briquettes and geo-polymer bricks/pavers wherein almost all constituents of the MSW are segregated into combustible and non-combustible material composition, such that all the combustible MSW composition is segregated, shredded, squeezed, dried, pulverized, de-volatized, carbonized and mixed with geopolymer binding agents and converted into high calorific value fuel in the form of geopolymer pellets and geopolymerbriquettes.

Another object of this invention is to provide a method and an apparatus in converting all municipal solid waste into pellets/briquettes and bricks/pavers wherein almost all constituents of the MSW are segregated into combustible and non-combustible material composition, such that all the combustible MSW composition is segregated, shredded, squeezed, dried, pulverized, de-volatized, carbonized and mixed with organic or inorganic binding agents like starch/tar etc and converted into high calorific value fuel pellets and briquettes

Another object of this invention is to provide a method and an apparatus in converting all municipal solid waste into pellets/briquettes and bricks/pavers wherein almost all constituents of the MSW are segregated into combustible and non-combustible material composition, such that all the combustible MSW composition is segregated, shredded, squeezed, dried, pulverized, de-volatized, carbonized and converted into very high calorific value fuel pellets and briquettes with low ash and low moisture content by means of using high rpm heat compacting pelletization technology without using binding agents.

Yet another object of this invention is to provide a method and an apparatusin converting all municipal solid waste into geo-polymer pellets/briquettes and geo-polymer bricks/pavers wherein, after segregation of all constituents of the MSW into combustible and non-combustible material composition, the Non-combustible materials like glass, stone, mud and debris are crushed and pulverized, and mixed with geo polymer binder and china clay/fly ash using geopolymerization process and molded into geopolymer bricks and geopolymer paver blocks.

Yet another object of this invention is to provide a method and an apparatusin converting all municipal solid waste into pellets/briquettes and bricks/pavers wherein, after segregation of all constituents of the MSW into combustible and non-combustible material composition, the Non-combustible materials like glass, stone, mud and debris are crushed and pulverized, and mixed with china clay/fly ash, quarry dust/chips, river sand, cement and molded into fly ash bricks and fly ash paver blocks.

It is yet another object of this invention to provide a method and an apparatus in converting all municipal solid waste into geo-polymer pellets/briquettes and geo-polymer bricks/pavers wherein the only materials sorted out are the metals (ferrous and non-ferrous) which are separated at the first stage and collected and then sent for recycling.

It is yet another object of this invention to provide a method and an apparatus in converting all municipal solid waste into geo-polymer pellets/briquettes and geo-polymer bricks/paversby ensuring clean handling of MSW right from the source till the final processing area without need for segregation at source.

It is yet another object of this invention to provide a method and an apparatus to handle both sorted and unsorted MSW in converting all municipal solid waste into geo-polymer pellets/briquettes and geo-polymer bricks/pavers.

It is yet another object of this invention to provide a method and an apparatus in converting all municipal solid waste into geo-polymer pellets/briquettes and geo-polymer bricks/pavers wherein the whole process or-the method forms end to end closed loop system, such that the output of one stage becomes input to the next stage and the chain goes till the end.

It is yet another object of this invention to provide a method and an apparatus in converting all municipal solid waste into geo-polymer pellets/briquettes and geo-polymer bricks wherein the entire process as a whole from input to output is closely linked and integrated and seems to be happening in almost completely automated sequences.

### STATEMENT OF INVENTION

Thus according to this invention a novel method in converting all municipal solid waste into pellets and geo-polymer pellets/briquettes and geo-polymer bricks/pavers comprises of
i. unsorted MSW being moved from the dump yard through a conveyor belt onto a ramp and then passing through a bag opener for opening household bags containing MSW;
ii. crushing the opened household bags containing MSW;
iii. simultaneously crushing the breakable items such as building materials into finer particles and squeezing unbreakable items to remove liquid contents, and delivering the liquid into an effluent treatment plant;
iv. compressing the unbreakable and breaking the breakable components of MSW which travels through a magnetic separator for removing ferrous things and eddy current separator for non-ferrous things before being put into trommel;
v. separating by a trommel for separation into substantially combustible and non-combustible MSW and Combustible MSW to pass through inter particle collision drier, inter particle collision pulverizer and de-volatizing and carbonizing reactors and cooler to make into combustible high caloric value pellets and briquettes and Non-Combustible MSW to pass through inter particle collision crusher and pan mixer for making into bricks and paver blocks;

Converting the whole unsorted municipal solid waste into geo-polymer pellets or briquettes and geo-polymer bricks and paver blocks with minimal recycling, zero residue waste and zero land filling requirements. According to another feature of this invention in the method for converting all municipal solid waste into geo-polymer pellets/briquettes and geo-polymer bricks/paver blocks bag opening and crushing is done with the spikes of the bag opener and shearing the household bags containing unsorted MSW and letting unsorted MSW into the wedge between the concurrently rolling two stage serrated double drum crusher with heavy colliding springs crushing and removing 50% of liquid content of unsorted MSW.

According to yet another feature of this invention in the method for converting all municipal solid waste into pellets and geo-polymer pellets/briquettes and geo-polymer bricks/pavers, drying the shredded combustible MSW is done by a drying process by heat generated due to collision of inter particles due to their rotation caused by a flat blades on a rotating shaft across the stationary flat blades on the walls, and the drum shaped drier at high speed resulting in heat generation and drying while an inbuilt moisture absorber sucks the moisture through a moisture separating, heat exchanging, dust collecting cyclone system leaving combustible MSW dry.

According to another feature of this invention in the method for converting all municipal solid waste into pellets and geo-polymer pellets/briquettes and geo-polymer bricks/pavers, pulverizing by inter particle collision pulverizer is done by cutting the dry combustible MSW further into finer particles, performing moisture separating, heat exchanging and dust collecting.

According to another feature of this invention in the method for converting all municipal solid waste into geo-polymer pellets/briquettes and geo-polymer bricks/pavers, de-volatizing and carbonization of combustible MSW is done by passing them through five stage reactor which heats up the combustible MSW step by step in first four stages by thermic fluid heat increasing process from 50 Degree Celsius at the first stage to 300 degree in the fourth stage ensuring carbonization and controlled removal of volatile gases.

According to yet another feature of this invention in the method for converting all municipal solid waste into geo-polymer pellets/briquettes and geo-polymer bricks, the cooling of combustible MSW is done in the fifth stage of the five stage reactor by a single stage cooling system at the bottom intensifying the density of carbon molecules afterde-volatizing carbonization process converting the combustible MSW into high calorific value fuel, reducing moisture and removing of volatile gases.

According to another feature of this invention in the method for converting all municipal solid waste into geo-polymer pellets/briquettes and geo-polymer bricks/pavers, crushing of the trommel separated non-combustible MSW is done by inter particle collision crusher that contains both stationary sharp blades and flat moving blades which move at high speed causing the non-combustible MSW repeatedly toget crushed and shredded and converted into powder form during which heat generates and the moisture is removed through a moisture separating, heat exchanging, dust collecting cyclone system.

According to another feature of this invention an apparatus for carrying out the method in converting all municipal solid waste into geo-polymer pellets/briquettes and geo-polymer bricks/pavers comprises of
i. a conveyor belt for moving the unsorted MSW from the dump yard onto a ramp and made to pass through a bag opener;
ii. a bag opener and crusher for opening household bags containing unsorted

MSW and for crushing and squeezing to remove liquid content;
iii. a magnetic separator for removing ferrous things and eddy current separator for removing non-ferrous things to compress unbreakable and break the breakable components of from unsorted MSW before being put into a trommel;
iv. a trommel for size separation of unsorted MSW into substantially combustible and non-combustible fractions;
v. inter particle collision drier, inter particle collision pulverizer and de-volatizing and carbonization reactors to make combustible MSW into combustible high calorific value pellets/briquettes;
vi. Inter particle collision crusher to crush the non-combustible MSW and a pan mixer and brick/paver molding plant to make into bricks or paver blocks;

According to yet another feature of this invention an apparatus for carrying out the method in converting all municipal solid waste into geo-polymer pellets/briquettes and geo-polymer bricks/pavers, the trommel is for size separation and inter particle collision crusher and pan mixer, molder and drier to process the non-combustible MSW with addition of quarry dust chips and fly ash to add strength and geo-polymer agents for inseparable bonding.

According to another feature of this invention an apparatus for carrying out the method in converting all municipal solid waste into geo-polymer pellets/briquettes and geo-polymer bricks/pavers, the bag opener has spikes in the bag opener for shearing the household bags containing unsorted MSW and twin stage serrated double rolling drum crushers for letting unsorted MSW into the wedge between the concurrently rolling two stage serrated double drum crusher with heavy colliding springs simultaneously crushing the breakable items such as building materials into finer particles and squeezing unbreakable items such as food waste and plastic and removing 50% of liquid content of unsorted MSW and delivering it to an effluent treatment plant.

According to another feature of this invention an apparatus for carrying out the method in converting all municipal solid waste into geo-polymer pellets/briquettes and geo-polymer bricks, the fluid extractive compressor has a top end inlet for combustible MSW to pass inside and an outlet placed at the bottom for compressed combustible MSW to pass through which completes one cycle of compression and retraction every minute as two pistons moving against each other with heavy force for compressing and thereafter the front end piston retracting and back end piston pushing the compressed combustible MSW instantaneously until it falls through outlet simultaneously letting liquid content to the effluent treatment plant.

According to yet another feature of this invention an apparatus for carrying out the method in converting all municipal solid waste into geo-polymer pellets/briquettes and geo-polymer bricks, inter particle collision drier contains an inlet for 5 MM shredded combustible MSW to under-go a drying process due to heat generated by collision of inter particles, when rotating flat blades mounted on a shaft moves at high speed across the stationary flat blades fitted on the walls, the drum shaped drier at high speed resulting in heat generation and drying while an inbuilt moisture absorber sucks the moisture through a moisture separating, heat exchanging, dust collecting cyclone system leaving combustible MSW dry.

According to another feature of this invention an apparatus for carrying out the method in converting all municipal solid waste into geo-polymer pellets/briquettes and geo-polymer bricks, inter particle collision drier contain stop shutter and bottom shutter which are in turn operated by a PLC controlled hydraulic system.

According to yet another feature of this invention an apparatus for carrying out the method in converting all municipal solid waste into geo-polymer pellets/briquettes and geo-polymer bricks, the inter particle collision pulverizer has sharp moving as well as sharp stationary blades of unique shape of sickle devices to cut the dry combustible MSW further into finer particles, for moisture separating, heat exchanging dust collecting.

According to another feature of this invention an apparatus for carrying out the method in converting all municipal solid waste into geo-polymer pellets/briquettes and geo-polymer bricks, inter particle collision pulverizer has dust collecting cyclone system, provided with an input feeding and output discharging screw conveyor.

According to another feature of this invention an apparatus for carrying out the method in converting all municipal solid waste into geo-polymer pellets/briquettes and geo-polymer bricks, the de-volatizing and carbonization reactor consists on its top an inlet for the dry Combustible MSW to pass through five stage reactor that heats up the combustible MSW in four stages step by step fashion and cools in the fifth stage.

According to another feature of this invention an apparatus for carrying out the method in converting all municipal solid waste into geo-polymer pellets\briquettes and geo-polymer bricks, the de-volatizing and carbonization reactor consists of five stage reactor that heats up the Combustible MSW in step by step by thermic fluid heat increasing process from 50 Degree Celsius at the first stage to 300 degree in the fourth stage ensuring carbonization and controlled removal of volatile gases.

According to another feature of this invention an apparatus for carrying out the method in converting all municipal solid waste into geo-polymer pellets\briquettes and geo-polymer bricks, five stage reactor that heats up the Combustible MSW in four stages step by step fashion and cools in the fifth stage, the single stage cooling system provided at the bottom is for intensifying the density of carbon molecules after de-volatizing carbonization process involving the conversion of combustible MSW into high calorific value fuel, reduction of moisture and maximum removal of volatile gases.

According to another feature of this invention an apparatus for carrying out the method in converting all municipal solid waste into geo-polymer pellets/briquettes and geo-polymer bricks, the inter particle collision crusher contains both stationary sharp blades and flat moving blades which move at high speed due to which the non-combustible MSW repeatedly crushed and shredded and converted into powder form, during which heat generates and moisture removed through a moisture separating, heat exchanging, dust collecting cyclone system.

According to another feature of this invention a bag opener with twin stage double rolling drum crushers provided with the spikes for shearing the household bags containing unsorted MSW and letting unsorted MSW into the wedge between the concurrently rolling two stage serrated double drum crusher with heavy colliding springs crushing and removing 50% of liquid content of unsorted MSW.

According to another feature of this invention a fluid extractive compressor having a top end inlet for putting inside combustible MSW and an outlet placed at the bottom for passing the compressed combustible MSW which completes one cycle compression and retraction every minute as two pistons moving against each other with heavy force for compressing and thereafter the front end piston retracting and back end piston pushing the compressed combustible MSW instantaneously until it falls through outlet simultaneously letting liquid content to the effluent treatment plant.

According to another feature of this invention an inter particle collision drier containing an inlet for 5 MM shredded combustible MSW to go through a drying process due to heat generated by collision of inter particles, when rotating flat blades mounted on a shaft moves at high speed across the stationary flat blades fitted on the walls, the drum shaped drier at high speed resulting in heat generation and drying while an inbuilt moisture absorber sucks the moisture through a moisture separating, heat exchanging, dust collecting cyclone system leaving combustible MSW dry.

According to another feature of this invention an inter particle collision pulverizer provided with sharp moving as well as sharp stationary blades of unique shape of sickle devices that breaks the dry combustible MSW further into finer particles which has moisture separating, heat exchanging dust collecting cyclone system, which in turn has a input feeding and output discharging screw conveyor.

According to another feature of this invention an de-volatizing and carbonization reactor having on its top an inlet for the dry combustible MSW to pass through five stage reactor that heats up the combustible MSW in four stages in step by step by thermic fluid heat increasing process from 50 Degree Celsius at the first stage to 300 degree in the fourth stage ensuring carbonization and controlled removal of volatile gases and in the fifth stage a single stage cooling system at the bottom to intensify the density of carbon molecules after de-volatizing carbonization process involving the conversion of combustible MSW into high calorific value fuel, reduction of moisture and maximum removal of volatile gases.

According to another feature of this invention an inter particle collision crusher comprising both stationary sharp blades and flat moving blades which move at high speed due to which the non-combustible MSW repeatedly crushed and shredded and converted into powder form during which heat generates and the moisture is removed through a moisture separating, heat exchanging dust collecting cyclone system.

According to another feature of this invention after segregating all constituents of the MSW into combustible and non-combustible material composition, such that all the combustible MSW composition is segregated, shredded, squeezed, dried, pulverized, de-volatized, carbonized and mixed with organic or inorganic binding agents like starch/tar etc and converted into high calorific value fuel pellets and briquettes

According to another feature of this invention after segregating all constituents of the MSW into combustible and non-combustible material composition, such that all the combustible MSW composition is segregated, shredded, squeezed, dried, pulverized, de-volatized, carbonized and converted into very high calorific value fuel pellets and briquettes with low ash and low moisture content by means of using high rpm heat compacting pelletization technology without using binding agents.

According to another feature of this invention after segregating all constituents of the MSW into combustible and non-combustible material composition, converting the Non-combustible materials like glass, stone, mud and debris are crushed and pulverized, and mixed with china clay/fly ash, quarry dust/chips , river sand, cement and molded into fly ash bricks and fly ash paver blocks.

### BRIEF DESCRIPTION OF THE DRAWINGS

The accompanying drawings describe the invention in greater detail containing same reference numbers across figures to refer to like parts, machines, equipments or components.

FIG. 1 shows a block diagram of this whole invention to produce the combustible and noncombustible material in the final production of pellets/briquettes or bricks/paver blocks respectively from the unsorted MSW collected.

FIG. 2 shows a detailed block diagram showing fully about the conversion of the combustible MSW into pellets/briquettes.

FIG. 3 shows a detailed block diagram showing clearly about the conversion of the non-combustible MSW into pellets and paver blocks.

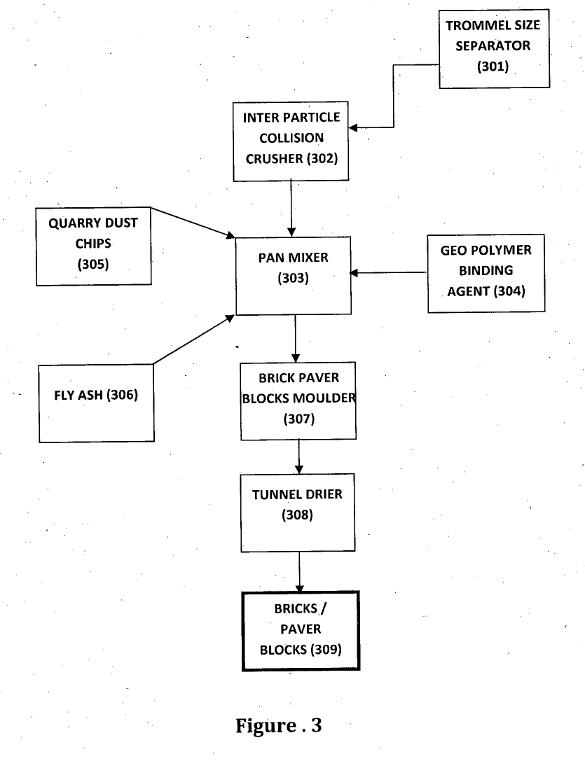

FIG. 4 is a perspective view of Bag opener cum crusher unit of the present invention.

FIG. 5 is a perspective view of Fluid extractive compressor unit connected between the 10 MM output blade shredder and 5 MM output blade shredder of the present invention.

FIG. 6 is a perspective view of the Inter-particle collision drier unit of the present invention.

FIG. 7 is a perspective view of the Inter-particle collision pulverizer unit of the present invention.

FIG. 8 is a perspective view of the De-volatizing Carbonization Reactor unit of the present invention.

FIG. 9 is a perspective view of the Inter-particle collision crusher unit of the present invention.

### DESCRIPTION OF THE INVENTION IN NUTSHELL

The machinery/apparatus and process of this invention do the conversion of the MSW into combustible and non-combustible components. Those components are converted into fuel of high calorific value in the form of pellets/briquettes and bricks/paver blocks. The combustible components of MSW includes materials consisting of forest waste, food waste, agricultural waste, backyard waste, plastics, papers & card boards, textile waste, tires & rubbers etc.

The non-combustible components of MSW conist of inert waste which is neither chemically nor biologically reactive and will not decompose including building materials, glass, bottles and such things.

MSW always contains liquid content which has to be first separated besides removing inert materials. The layout of the Apparatus commences with an automatic chain conveyor feeder.

At the first stage of the Apparatus the unsorted MSW is transported through a conveyor into specially designed combined bag opening and crushing unit called as bag opener cum crusher that does two functions simultaneously. It removes almost completely the liquid content which are collected and diverted through pipes to an effluent treatment plant [ETP] and the inert materials are crushed and broken into particles of small sizes.

The crushed and squeezed MSW which is an assorted mixture is passed through metal separators in which both ferrous and non-ferrous metals are separated, the MSW free from metals passes through a twin drum trommel. The trommel in addition to size separation, it particularly divides the MSW into two major constituents consisting of combustible and non-combustible compositions.

Thereafter the invention takes the entire combustible MSW into a series of processes such as primary shredding, double compression squeezing, and secondary shredding, inter particle drying, inter particle pulverizing and the like. In all these stages the size of the particle is reduced gradually and converted into powder form. Simultaneously the moisture reduction takes place at all these stages due to inter particle collision.

Finally the combustible low moisture powder is passed through to de-volatizing carbonization reactor, here the particles carbon concentration is increased, the process is carried out in the absence of oxygen in such a way that volatile gases are contained and the density of the particle is increased. The output from the de-volatizing carbonization reactor is either mixed with geo polymer binding agents/tar/starch etc., or by high speed compacting to form pellets and briquettes of high calorific value. On the other hand the non-combustible or inert MSW materials consisting of Stone, Glass, Mud and the like in the MSW mixture is passed through inter particle crusher and mixed with geo-polymer agents and converted into bricks and pavers after molding and drying.

Thus the invention results in two useful products as aforesaid. Even the solid waste generated after liquid that is put through the ETP is brought back to the first stage as a result of which there is not only “zero effluent discharge” but also the entire MSW is converted into two Products enabling the combustible pellets or briquettes for being used for fuel as a coal and the effluent free non-combustible bricks for being used as building blocks.

The invention also results in generating two by-products too. When the gas from de-volatizing carbonization reactor is passed through gas cleaning system, a condensed “Tar” and Syngas is produced respectively, while Tar is used as a binding agent for pellet & briquette conversion and the syngas is used to heat the reactor.

### DETAILED DESCRIPTION OF THE INVENTION

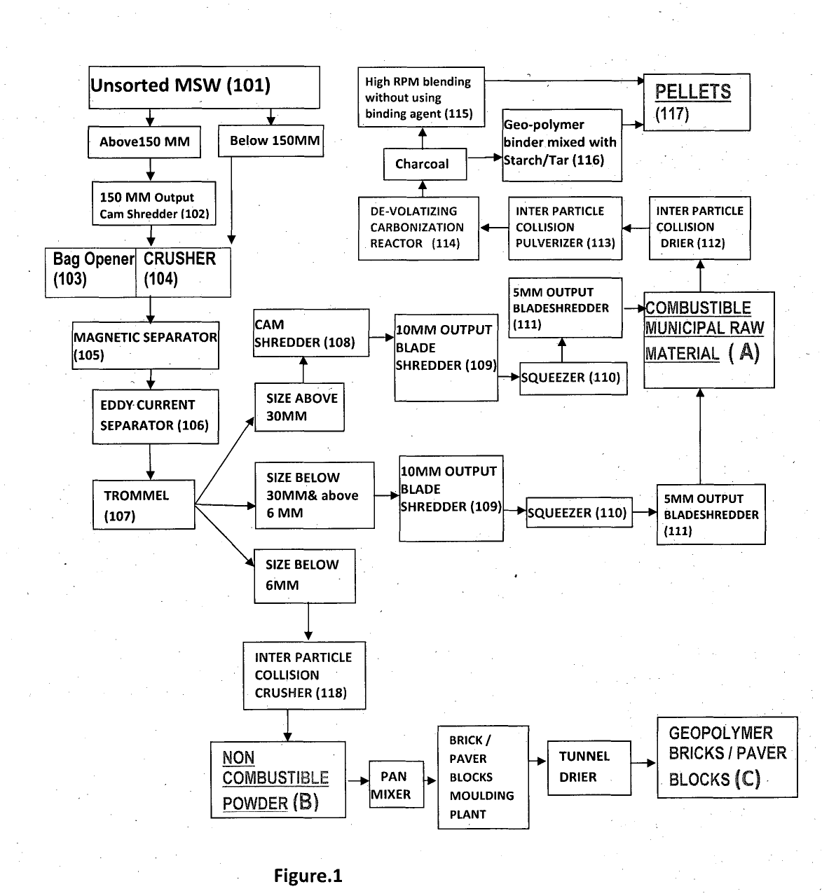

In FIG. 1 the blocks are serially numbered from 101 to 119. 101 is the stage where the unsorted municipal solid waste (MSW) is collected from the dump yard. Unsorted MSW, consisting of food wastes, paper, cardboard, plastics, textiles, glass, metals, wood, street sweepings, landscape and tree trimmings and general wastes from parks, beaches, and other recreation areas etc., collected from the dump yard, goes through a ramp to go into a bag opener and crusher.

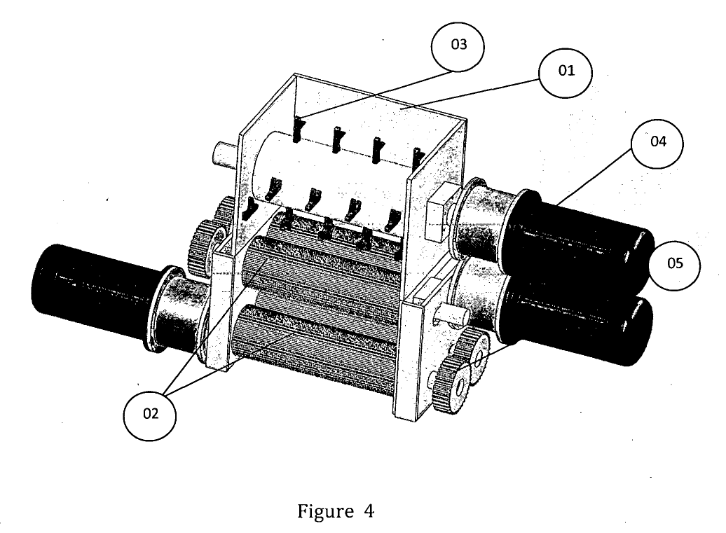

Unsorted MSW from dump yard 101,is first sorted out as MSW which is above 150 MM to pass through the 150 MM output CAM shredder (102) and then it is transferred manually into a bag opener cum crusher (103 & 104). But the MSW which is sorted out as below 150 MM size is passed directly through a conveyer to a combined unit of “Bag Opener and Crusher” 103 & 104 respectively. The apparatus Bag opener cum crusher is illustrated in FIG. 4. In the bag opener cum crusher, bag opener is the first receptacle of the unsorted MSW which is located at a height above 15 ft. from the ground level, the bag opener Part No. 1 receives the unsorted MSW which are below 150 mm, the MSW that gets dropped in a continuous process makes it possible for the dropped MSW to go through the crusher as the bag gets opened simultaneously. The combined unit is rotated by motor and gear system Parts No. 4 & 5. The bag opener consists of a rotating shaft with spikes Part No. 3, opens and separates the bags containing MSW through piers and tearing action.

As the bag is opened MSW is moved into the crusher Part No. 2. The reverse flow of the material from the crusher is avoided due to vertical gravity feed & unidirectional input from the bag opener.

The bag opening stage is primary and important stage where in all the unsorted MSW materials are uncovered and opened for further processing. In the absence of bag opening stage, there may be a possibility of crushable waste getting skipped and slipping into next stage. If such things escape, it may not get exposed to the ferrous and non-ferrous separators which can create undesired problems and delays and can even result in halting of the operation due to safety or emergency tripping of the process line if the material gets struck at later stages.

The crusher consists of multiple rotating roller drums Part No. 3, with serrated ridges tangential to the axis of rotation of the crusher drum in the first stage and serrated ridges perpendicular to the axis of rotation of the crusher drum in the second stage in order to avoid slipping of material and increases the efficiency of the crusher. Here, after this stage all MSW materials are passed through the crusher (104) where they are squeezed and the materials like glass, stone, debris are crushed. Crushing separates materials such as nails and screws deeply embedded to lose grip which helps when the unsorted MSW goes through the subsequent stage where magnetic and eddy current separation takes place to remove ferrous and non-ferrous items.

The crushed and squeezed MSW is transported through conveyor to metal separators 105 & 106. In this process ferrous and nonferrous metals are separated, the ferrous metals are separated in the magnetic separator 105 where in the MSW is passed through an overhead magnetic rolling belt which is placed perpendicular to the line of chain conveyor. The magnetic rolling belt collects the ferrous materials from the MSW. The MSW minus ferrous things is passed through eddy current separator 106 which is placed along the line of conveying system. The eddy current forces are created when a magnetic rotor turns at a high speed and repels non-ferrous materials with varying degrees of force depending on their metallic composition. In this process non-ferrous materials like aluminum, copper etc., are separated from wood, plastic etc. and ejected out and collected in a container. The collected materials from 105 & 106 are sent for recycling.

Separation of all the ferrous and non-ferrous materials are separated by magnetic and eddy current separators (105 & 106) shall be taken as the Stage 1 separation. I. The processed MSW is then sent to an automatic feeder by means of a conveyor into a twin trommel with 30 mm inner screen and 6 mm outer screen, which divides the processed MSW into heaps of three categories, one for materials above 30 mm and one below 30 mm and the third one for materials of less than 6 mm. In the second stage of separation, the separation of the combustible and non-combustible materials happens at twin drum trommel separator (107), where the MSW is separated into above 30 mm, below 30 mm and below 6 mm respectively. The above 30 mm solid waste then sent to an automatic feeder by means of a conveyer to a CAM shredder. The shredded solid waste from CAM shredder and below 30 mm MSW which are combustible fraction is further shredded by sending it to an automatic feeder by means of a conveyer to a 10 mm output blade shredder.

In the shredding stage I the cam shredder (108) and blade shredder I (109), ensures the size of the shredded combustible MSW is 10mm; In the Shredding stage II (109), the 10 mm shredded combustible MSW is shredded to 4 to 5 mm by blade shredder II (109);

The remaining MSW which predominantly comprising of squeezed combustible materials passing through the second screen of size 30 mm and the particles above 30 mm size passes directly to the next stage. The next stage is where the combustible MSW conversion takes place. Due to size separation, the trommel automatically separates the MSW into combustible and non-combustible composition. From here onwards, the process actually takes two different routes one for processing combustible MSW and another for Non-combustible MSW.

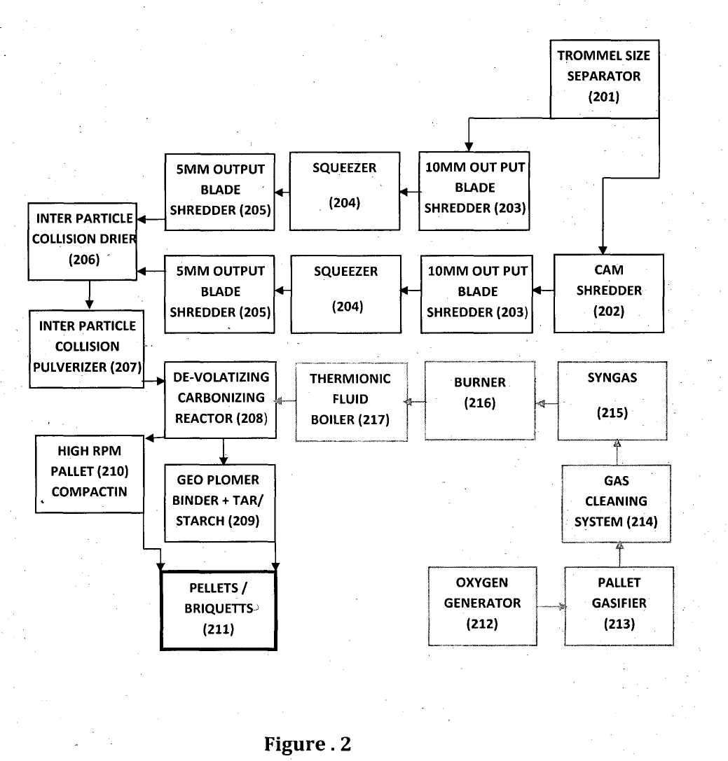

FIG. 2 consists of blocks 201 to 217, depicting the manner in which combustible MSW are converted into fuel of high calorific value through a series of sequential processes.

In the fluid extraction stage the shredded material is compressed in a fluid extractive compressor (110). The shredded MSW from blade shredder is then sent to an automatic feeder by means of a conveyer into a fluid extractive compressor to remove moisture. Effluent from fluid extractive compressor is treated in a waste water treatment plant and treated water is used in heat exchangers and for domestic cleaning purposes. The above 30 mm material is passed through a belt conveyor into a cam shredder 202 for size reduction below 30 mm. The size reduction is achieved by means of horizontal inward rotating blades (like a cam) with spacers in between.

The blades and spacers are arranged in an orderly fashion on two rotating shafts rotated by two electric motor and gear system. This shreds the above 30 mm fed combustible MSW to a lesser size. The 6 to 30 mm combustible MSW as mentioned and the less than 30 mm output MSW from cam shredder 202 passes through same process in two identical lines which comprises of further shredding and material compression actions.

The placing of two identical processes enables handling of higher volume of input combustible MSW so has to achieve higher process output at this stage.

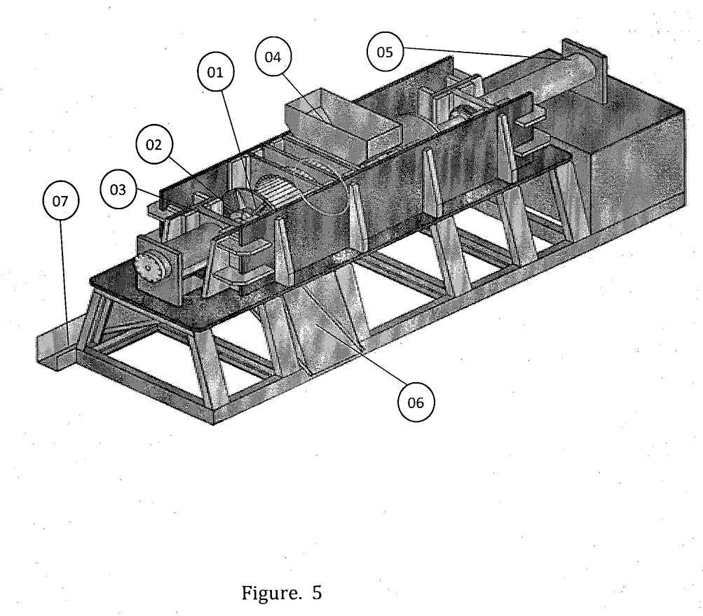

All 6 to 30 mm combustible MSW is further shredded to a size between 5 to 10 mm in a blade shredder 203. It comprises of sharp blades rotating in a horizontal shaft supported by bearings, the blades are arranged across the rotating blades in a staggered manner for effective shredding to a size between 5 mm to 10 mm. In order to get powdered char fuel with high calorific value and low moisture content from the combustible MSW, the material has to undergo further size reduction in the secondary twin line blade shredders block 205. For effective size reduction in the secondary shredder the moisture has to be reduced further. Size reduction is an essential requirement for combustible materials for achieving better carbon intensification at a later stage. To achieve this, combustible MSW from primary blade shredder 203 is passed through twin line fluid extraction process 204 in the double piston fluid extractive compressor as illustrated in FIG. 5.

The apparatus consists of double acting cylinders Parts No. 1 & 3. The cylinders and the mechanisms are operated by PLC controlled hydraulic system. The combustible MSW is drawn from primary shredder in to loading chamber Part No. 4. The material from the feeding hopper is pushed by the pressing cylinder Part No. 3, simultaneously the closing cylinder Part No. 1, is drawn inside for material compression. The MSW undergoes fluid extraction process due to the double acting compression between the two cylinders. Once the material compression is completed the closing cylinder retracts back and the pressing cylinder pushes the compressed MSW further to the material delivery tray, Part No. 6. The latchet which comes out during squeezing action is collected in the channel Part No. 7 of and in turn sent to ETP for treatment. Thus the apparatus further reduces the moisture content of combustible MSW by means of material compression which brings out the effluent from the waste through, “double piston compression technology”. In this stage moisture is further reduced between 10 to 15% which in turn enables the combustible MSW to be shredded below the size of 5 mm in the twin line blade shredders block No. 205 of FIG. 2, which is a 5 mm output blade shredder. It comprises of blades rotating in a horizontal shaft supported by bearings, the blades are arranged in multi stages in a staggered manner in order to shred the combustible MSW effectively to a size below 5 mm.

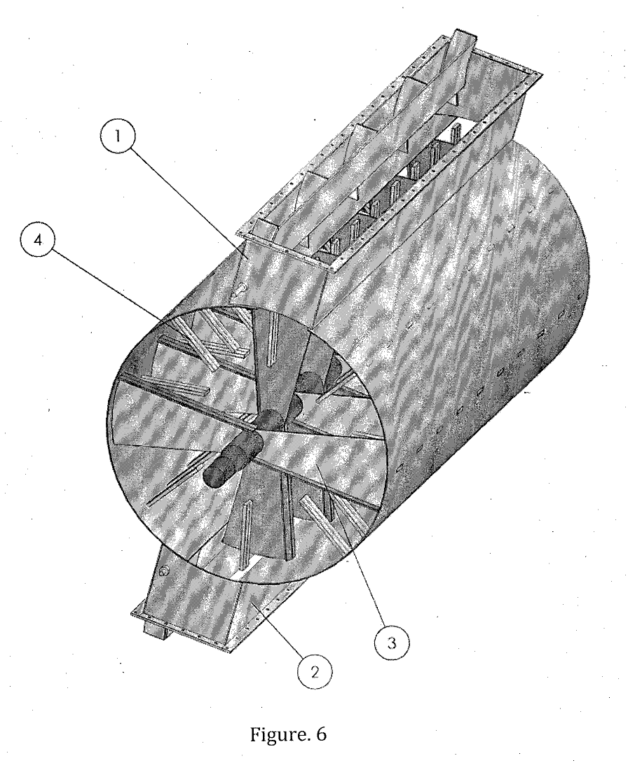

The process from 206 to 208 are twin line process and the processes from 209 is again single line process the combustible shredded MSW below 5 mm from 205 is passed through a conveyor to inter particle collision drier 206; the apparatus is illustrated in FIG. 6. It's a novel apparatus used to dry combustible waste, of size less than 5 mm. It comprises of a horizontal cylinder with a rotating shaft which is balanced by bearings at both ends. The shaft is rotated between 1500 RPM to 3000 RPM by an electric motor fitted with Variable Frequency Drive [VFD] which varies the speed according to the output requirement The shaft has rotating replaceable flat blades Part No. 3 which on one side angled at 60 degrees over fan blade shaped frame, which when rotated at high speed, makes the particles to colloid with each other: The inner wall is fitted with flat stationary replaceable flat blades Part No. 4. The stationary flat blade creates obstruction to the rotating particles and helps in stirring and it also boosts inter particle collision. The apparatus has got a top shutter part no. 1 and bottom shutter Part No. 2 which is operated by means of Programmed Logic Controls [PLC] controlled hydraulic system. This helps in feeding and discharging of particles in a cycled manner. The cylindrical drier has two doors through which maintenance of the machine can be carried out and also helps in replacing the blades when needed. The door operation and material conveying screw conveyors are controlled by PLC operated hydraulic system.

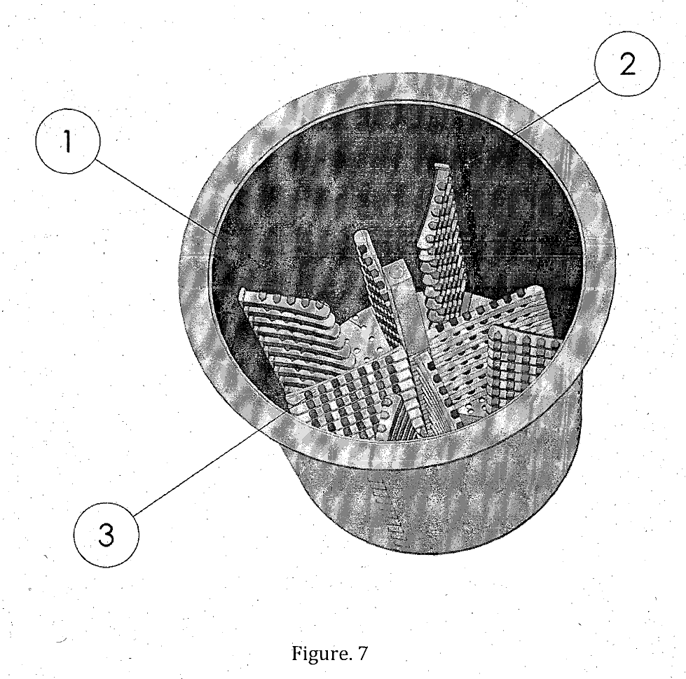

The heat generated by the inter particle collision vaporizes the moisture around the particle. The moisture is removed through a hollow pipe attached to one of the cylinder cover. This pipe is connected to a heat exchanger to heat the vapor, other end of heat exchanger connected to a suction blower which is attached to a dust collecting cyclone system. The cyclone separates the dust and the dust collects in the bag kept beneath the cyclone. The moisture evaporates through the upper end of the cyclone to the atmosphere. The dust collected in the bag is mixed with the MSW for further processing. The, less than 5 mm size dried combustible MSW from Inter Particle Collision Drier block no. 206 as explained in FIG. 2 is passed to Inter particle collision pulverizer, Block No. 207 of FIG. 2, illustrated in FIG. 7. It's a novel apparatus which is used to convert dry combustible waste less than 5 mm into powder form of size less than 1 mm.

Inter Particle Collision Pulverizer consists of a vertical cone shaped cylinder with a rotating shaft balanced by bearings in top and bottom ends, which is rotated between 1500 RPM to 3000 RPM by an electric motorfitted with VFD which varies the speed according to the output requirement The rotating shaft has specially designed curved periodically replaceable sharp blades Part No. 3 which is fixed on the rotating shaft, which at highspeed, pulverizes the particles and makes the particle to collide with each other. The inner wall has curved sharp periodically replaceable stationary blades Part No. 2 which creates obstruction to the stirring of the particle, shearing of particles, makes the particle to collide with each other and at the same time pulverizes the particles. The cylinder has two doors through which maintenance of the machine can be carried out and also helps in replacing the blades when needed. The door operation and material conveying screw conveyors are controlled by Programmed Logic Controls operated hydraulic system.

In the Inter Particle. Collision Pulverizer too, the particle collision generates heat which vaporizes the moisture contents from the particle. The moisture is removed through a hollow pipe attached to one of the cylinder cover. This pipe is connected to a heat exchanger to heat the vapour, other end of heat exchanger connected to a suction blower which is attached to a dust collecting cyclone system. The cyclone separates the dust and the dust collects in the bag kept beneath the cyclone. The moisture evaporates through the upper end of the cyclone to the atmosphere. The dust collected in the bag is mixed with the MSW for further processing. The apparatus IPCP pulverizes the below 5 mm combustible MSW to powder form to a size below 1 mm and also further reduces the moisture from the particle, the pulverized dry powder when passed to de-volatizing and carbonization reactorgets converted into char fuel of high calorific value having low ash and low moisture content.

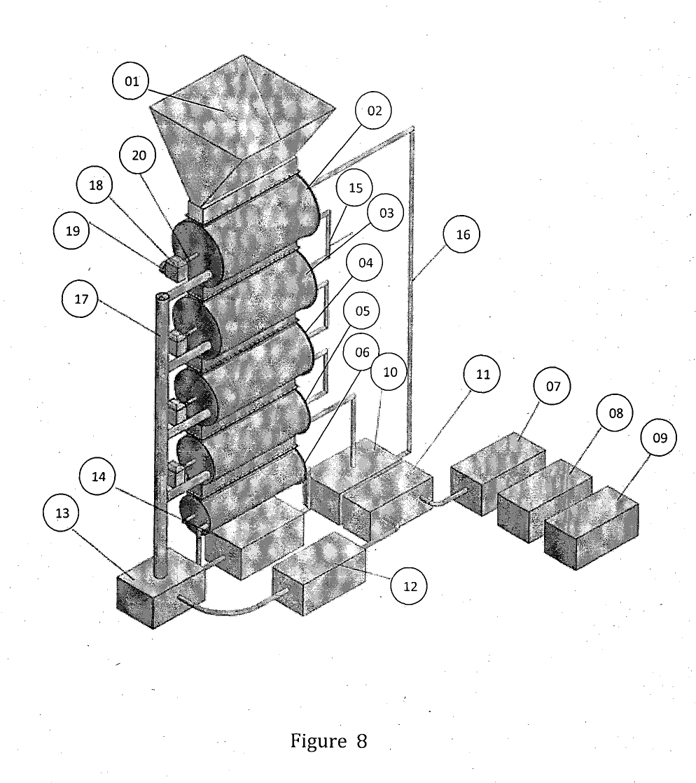

The dried and pulverized powder from inter particle collision pulverizer 207 is passed into de-volatizing carbonization reactor (DCR) 208; the apparatus is illustrated in FIG. 8. The apparatus is considered to be the heart of the combustible MSW conversion process. The apparatus consists of five cylinders with inner and outer shell positioned horizontally and placed vertically one above the other. Volume of each cylinder reduces gradually from top to bottom. Each cylinder will have a stirrer which in turn rotated by geared motor. Each cylinder will have top and bottom shutters which are controlled by PLC assisted hydraulic system so that discharge and filling of each cylinder is done in an orderly fashion from bottom to top so that in each chamber the raw material is held and stirred continuously for 10 minutes before getting discharged into next chamber from top to bottom.

Feeding hopper Part No. 1 with a double star lock system feeds raw material in to top cylinder Part No. 2 to ensure and maintain strict anaerobic (absence of oxygen) conditions. Bottom most system will have PLC controlled discharge system.

Top four cylinders Parts No. 2 to 5 will have thermic fluid heating jacket system Part No. 15 and bottom most cylinder Part No. 06 is surrounded by a water cooled jacket. Top cylinder is fitted with a hollow pipe for removal of left over moisture and air which would have got trapped along with the particles while feeding into the first cylinder from interparticle collision pulverizer. The pipe is connected to a heat exchanger to heat the vapor, the other end of heat exchanger connected to a suction blower which is attached to a dust collecting cyclone system. In this DCR also, there is dust collecting cyclone system. The cyclone separates the dust and the dust collects in the bag kept beneath the cyclone. The moisture evaporates through the upper end of the cyclone to the atmosphere. The dust collected in the bag is mixed with the MSW for further processing. The removal of moisture and air from the first cylinder of de-volatizing carbonization reactor ensures that the particle is free from moisture and more so the absence of oxygen during the carbonization process. The second cylinder to fourth have suction system attached to a gas cleaning system Part No. 07, after gas cleaning, the gas is stored in a buffer tank the compressed gas is then fed to a burner Part No. 11, which heats the thermic fluid boiler Part No. 10.

Through separate oxygen Part No. 9 (oxygen generator) fueled pellet gasification plant Part No. 8, the syngas is generated which after passing through gas cleaning system Part No. 7 is stored in a buffer tank, the gas is compressed and then fed to a burner Part No. 11 which heats the thermic fluid boiler Part No. 10.

Hot thermic fluid oil is circulated in first four cylinders in order to heat the raw materials the thermic fluid is circulated from bottom cylinder Part No. 5 one by one to top cylinders Part No. 2 so that temperature of the particle inside the cylinder is increased gradually. The bottom cylinder Part No. 6 is cooled by water jacket in order to densify the char powder.

The flow of hot thermic fluid transfers the heat to the MSW and loses its own heat gradually and the process is carried out in an anaerobic condition by double feeding and discharge system as a result of which maximum removal of volatile gas is achieved and collection too takes place gradually. The volatile gas is passed through a gas cleaning system Part No. 12 and results in production of syngas which is in turn reused in the burner Part No. 11 to heat the thermic fluid boiler Part No. 10.

The De-volatizing Carbonization Reactor is considered has the heart of the MSW conversion process as it not only removes volatile gases and moisture but also intensifies the carbon concentration which is known as carbonization

The powdered dry char from the reactor DCR 208 as explained in FIG. 2 is converted into pellets or briquettes in stages 209 & 210. The pellet/briquette formation process in 209 consists of mixing the dry powdered char from de-carbonization reactor 209 with geo-polymer binding base or with materials such as starch or tar. The pellet or briquette may also be formed as per the step in 210 where in it consists of High RPM pallet compacting process without any binding agent. The pellet formed in this process will, have very high caloric value, lowest ash content and lowest moisture content due to absence of binding agent and also due to high RPM rotation heat generating pallet compacting machine 210. The High calorific value, low ash content low moisture content fuel pellet/briquettes 211 are formed out of combustible MSW conversion processes.

Heating of thermic fluid happens through a separate process wherein the oxygen from oxygen generator 212 is supplied to pallet based gasifier system 213 the gas from the system is passed through a gas cleaning system 214, the compressed syngas 215 thus obtained from gas cleaning system is supplied to a burner 216 which heats up thermic fluid boiler 217.

The combustible MSW conversion consists of four major processes which happen at specific stages they are 1) shredding 2) moisture reduction 3) removal of volatile gas 4) increasing the carbon concentration. While the process 1 & 2 shredding and moisture reduction happens at various stages the processes 3 & 4 happens in de-volatizing carbonization reactor (DCR) 208.

The moisture content of the unsorted MSW is about 45% by weight and the calorific value is around 1,000 to 1,200 Kcal. The calorific value determines the combustibility of the fuel. The calorific value is improved by reduction of the moisture content and increase of the carbon content. In the invention carbon content is increased in the carbonization reactor and the moisture content is reduced by six stage moisture reduction processes at various levels by way of crushing, shredding, fluid extracting, drying, pulverizing and devolatizing carbonization reactor Moisture reduction also reduces the smoking when the fuel is burnt. The moisture reduction and carbonization raises the calorific value of the combustible MSW fuel to the range of 5500 Kcal to 6500 Kcal and moisture content is reduced to 5% by weight and below.

First stage moisture removal from the unsorted MSW happens after bag opening in the multi Stage crushers where all squeezable MSW is squeezed and the water particle is collected and recycled at ETP.

Second stage moisture removal from combustible MSW happens in multiple stage shredding, single in cam shredder, I and II stage blade shredders respectively the water particle is collected and recycled at ETP.

Third stage moisture removal of shredded combustible MSW happens in fluid extractive compressor between I and II stage combustible MSW shredding process. This is an important step, wherein the 10 mm shredded combustible MSW from 1st stage shredder is passed through a fluid extractive compressor where the moisture is removed due to double acting piston compression technology and the partial shredded combustible MSW is passed to second stage shredding for size reduction of below 5 mm. The fluid is collected and sent to ETP.

Fourth stage moisture removal takes place in horizontal high RPM inter-particle collision drier, the 5 MM shredded combustible MSW particle from 5 MM blade shredder is passed through the inter particle collision drier where the moisture is removed due to the heat generated by inter particle collision, when the rotating shaft with flat moving blade is rotated at high speed against the flat fixed blade which is mounted on the wall of the drum shaped drier. The heat generated by the inter particle collision vaporizes the moisture content from the particle which is in turn removed by dust collecting moisture extracting cyclonic system fitted with heat exchanger. The dry 5 MM shredded combustible is passed to Inter particle collision pulverizer for conversion of the combustible MSW, particle into powder form.

Fifth stage moisture removal takes place in vertical cone shaped high RPM inter particle collision pulverizer, the dry 5 MM shredded combustible MSW particle from inter particle collision drier is passed to inter particle collision pulverizer where the moisture is removed due to the heat generated by inter particle collision, when the rotating shaft with sharp moving blade is rotated at high speed against the sharp fixed blade which is mounted on the wall of the cone shaped vertical pulverizer. The heat generated by the inter particle collision vaporizes the moisture content from the particle which is in turn removed by dust collecting moisture extracting cyclonic system fitted with heat exchanger. The dry combustible powder below 1 MM is passed to de-volatizing carbonization reactor for conversion of the dry powdered combustible MSW particle into carbonized char powder.

Sixth and final stage moisture removal takes place in de-volatizing carbonization reactor the dry powdered combustible MSW particle from inter particle collision pulverizer is passed to first cylinder of five stage de-volatizing carbonization reactor where the moisture is removed due to the heating of dry powdered combustible MSW by hot thermic fluid jacket surrounding the cylinder. This vaporizes the moisture content from the particle which is in turn removed by dust collecting moisture extracting cyclonic system fitted with heat exchanger. The dry combustible powder below 1 MM is passed to second cylinder of five stage de-volatizing carbonization reactor for conversion of the dry powdered combustible MSW particle into carbonized char powder.

The residue water line runs through various processes such as shredding, fluid extracting, etc., wherein the liquid collected from these processes are sent to effluent treatment plant ETP 220. The treated water from the ETP is reused with in the process line. The moisture collected from Inter particle collision drier, Inter particle collision pulverizer and devolitizing carbonization reactor is collected by moisture extracting cyclone system.

In another independent inter related process of conversion of all the non-combustible and inert materials which was crushed in crusher under goes metal separation where in both ferrous and nonferrous MSW particles are separated collected and sent for recycling. The below 6 mm size MSW from the Trommel comprising of crushed non-combustible and inert materials is processed and converted to bricks and paver blocks.

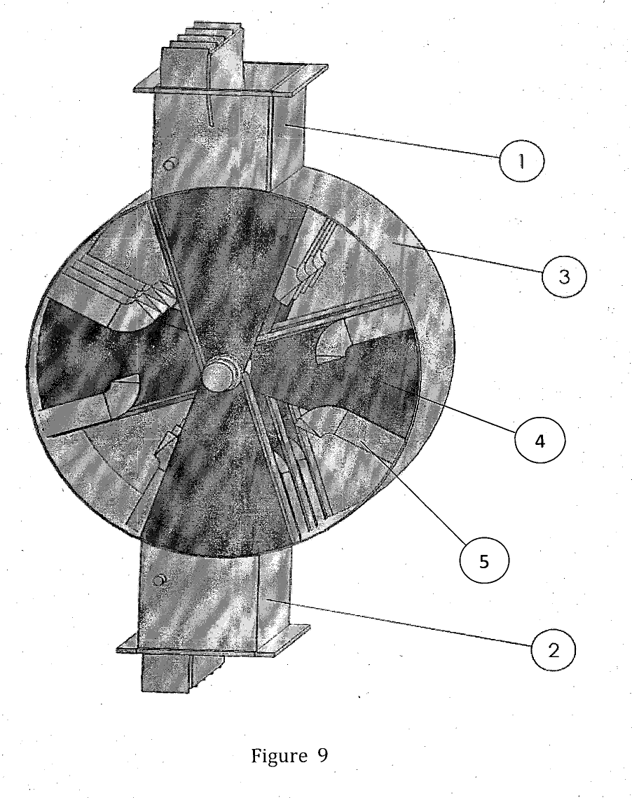

The Non-combustible MSW material of size below 6 mm is passed through inter-particle collision crusher (IPCC) the apparatus is illustrated in FIG. 9. Inter particle collision crusher is a novel apparatus which is used to shred and crush non-combustible waste, less than 6 mm which is received from outer 6 mm size separation screen of trommel.

The apparatus as explained consists of horizontal cylinder with a bearing mounted rotating shaft which is being rotated between 1500 RPM to 3000 RPM by an electric motor fitted with VFD the VFD varies the speed as per the required output desired to be in the form of powder.

The shaft has rotating fan shaped blade frame part no 4, on which replaceable flat blades are fixed on one side angled at 60 degrees. The shaft when rotated at high speed crushes the particles against the inner wall. The inner walls have replaceable sharp stationary blades part no. 5, which shreds the rotating particle and helps in converting the particles into smaller size. The apparatus has got a top shutter part no. 1 and bottom shutter part no. 2 which are operated by means of PLC controlled hydraulic system. This helps in feeding and discharging of particles in a cycled manner. The cylindrical apparatus has two doors through which maintenance of the machine can be carried out and also helps in replacing the blades when needed. The door operation and material conveying screw conveyors are controlled by Programmed Logic Controls operated hydraulic system.

The inter particle collision which occurs between the particles and the repeated shredding-and crushing action converts the particles into powder form due to the heating and crushing that takes place inside due to collision between particles.

Moisture is removed through a hollow pipe attached to the top of the cylinder cover. This pipe is connected to a heat exchanger which in turn connected to a suction blower which is attached to a dust collecting cyclone. The cyclone separates the dust and the dust collects in the bag kept beneath the cyclone. The moisture evaporates through the upper end of the cyclone to the atmosphere. The dust collected in the bag is mixed with the MSW for further processing.

This non-combustible MSW powder is mixed with geo-polymer binding agent (which is the product of a separate process called geopolimerization process) and other additional raw materials such as fly ash or quarry chips in a pan mixer 303. This mixture is molded in to geopolymer bricks and geopolymer paver blocks in a separate molding and drying process.

This non-combustible MSW powder can also be mixed with fly ash/china clay, quarry dust/chips, river sand, cement in a pan mixer 303. This mixture is molded in to fly ash bricks and fly ash blocks in a separate molding and water curing process.

The conversion of the non-combustible MSW into powder form with reduced moisture content is most important for further conversion into high quality bricks and pavers. Hence the Inter particle collision crusher plays a major role in the non-combustible MSW conversion to bricks and paver blocks.

Thus it leaves nothing for availability of any landfill area.

### THE UNIQUE FEATURES THAT MAKE THIS SYSTEM AN INVENTION

1) Maximum conversion of unsorted MSW to useful end products:
2) Holistic concept which converts both combustible and non-combustible materials from MSW to useful end products.
3) Avoidance of intermediate sorting of the MSW from the source to the processing area (developing countries)
4) Increase of calorific value by 6stage moisture removal:
5) Scalability and futuristic approach:
6) Closed loop system
7) Specialty of automated Sequences and Segregation System
8) Environment friendly and Non-polluting process:
9) MSW Powdering Pulverizer:
10) De-volatizing carbonization Reactor:
11) Crushing bag opener
12) Inter Particle Collision Drier
13) Char Palletization without binding agent
14) Double piston MSW fluid extracting compressor
15) Conversion of Non Combustible MSW to Geo-polymer Bricks/paver blocks

### ADVANTAGES

(1) This is a unique process where the Garbage from domestic (household) sector which forms the major constituent of the MSW can be transported without intervention of any intermediate sorting team.
(2) This process will avoid the pilferage and pre segregation and sorting by the garbage collection team to whom the government authorities/civic bodies have employed under contractual employment.
(3) These contract teams open the bags collected from the household and do a presorting and recover the valuables. This process is being not controlled by anybody, chances of mishandling and environment pollution could not be avoided.
(4) This invention can take care of present problem of utilizing already available dumped MSW which can be handled and converted to useful materials by applying 100% green waste management concept of reduce, recycle and reuse (3 R′s of waste management).
(5) This apparatus can handle the domestic waste without segregation and curbside dumping the space can be cleared. The inconveniences and the risks of smell, pollution etc., are avoided. Major intermediate handling, unhygienic handling by the presorting and segregating agents is totally avoided.
(6) The big menace of smell (stink, pilferage and misuse and recovery of valuables by the intermediate agents can be totally avoided through enforcement and thereby, can ensure clean handling of MSW right from the source till the processing area without need for segregation at source (segregation at source is a failure, it couldn't take off or sustain after initiation).
(7) This apparatus can handle the present problem of consuming/utilizing the MSW from dump yards and once it is utilized completely, the same setup can receive and process the MSW directly from the source area just by getting the pre packed. un segregated domestic waste transported to the processing area.
(8) This apparatus can handle both sorted and unsorted MSW.
(9) Automatic segregation of MSW into combustible and non-combustible (inert) materials and converting both into separate and different end products.
(10) This invention takes care and ensures zero pollution through air, water or land. (100% Environmental compliance is ensured)
(11) Air pollution is avoided by gaseous cleaning of the exhaust gas from the De-volatizing carbonization reactor there by the emissions are maintained within the permissible limit.
(12) Water pollution is avoided by collecting separated water at various process stages and treating them in effluent treatment plant. Recycled water is utilized for domestic use.
(13) The land pollution is also avoided by utilizing all the constituents of MSW with in the process, leaving behind only metals for recycling. The invention ensures that no residue is left for land filling.

While the present invention has been delineated by description of a preferred embodiment and the preferred embodiment has been described in considerable details with reference to the drawings, it is not contemplated to confine or in any way restrict the scope of the appended claims and their legal equivalence to such realization. Additional applications and adaptations will readily appear to those skilled in the art. The invention in its broader aspects is therefore not bound to the specific details that are representative of apparatus and method, and illustrative features shown and described herein. Accordingly, variations may be made from such details without departing from the utility, spirit and scope:of the substantive invention.

1. A novel method in converting all municipal solid waste into geo-polymer pellets/briquettes and geo-polymer bricks/paver blocks comprising of the following stages:
i. unsorted MSW being moved from the dump yard through a conveyor belt onto a ramp and then passing through a bag opener for opening household bags containing MSW;
ii. opening the household bags containing MSW;
iii. simultaneously crushing and squeezing as a result of which the breakable items such as building materials are broken into particles of smaller sizes and removing liquid content which gets delivered into an effluent treatment plant;
iv. putting unsorted MSW through a magnetic separator for removing ferrous things and eddy current separator for non-ferrous things before being put into trommel;
v. separating the unsorted dry MSW devoid of ferrous and non ferrous things by a trommel for separation into substantially combustible and non-combustible MSW where combustible MSW passes through inter particle collision drier, inter particle collision pulverizer and de-volatizing and carbonizing reactors resulting in creation combustible high calorific value pellets and briquettes and non-combustible MSW passes through inter particle collision crusher and pan mixer resulting in the making of bricks and paver blocks;
vi. and thereby converting the whole unsorted municipal solid waste into geo-polymer pellets or briquettes and geo-polymer bricks or paver blocks with minimal recycling, zero residue waste and zero land filling requirement.

2. A novel method in converting all municipal solid waste into geo-polymer pellets or briquettes and geo-polymer bricks or pavers as claimed in claim 1, wherein bag opening and crushing is done with the spikes of the bag opener and shearing the household bags containing unsorted MSW and letting unsorted MSW into the wedge between the concurrently rolling two stage serrated double drum crusher with heavy colliding springs crushing and removing 50% of liquid content of unsorted MSW.

3. A novel method in converting all municipal solid waste into geo-polymer pellets or briquettes and geo-polymer bricks or pavers as claimed in claim 1, wherein drying the shredded combustible MSW is done by a heating process generated by collision of inter particles due to their rotation caused by a flat blades on a rotating shaft across the stationary flat blades on the walls, and the drum shaped inter particle drier at high speed resulting in heat generation and drying while an inbuilt moisture absorber sucks the moisture through a moisture separating, heat exchanging, dust collecting cyclone system leaving combustible MSW dry.

4. A novel method in converting all municipal solid waste into geo-polymer pellets or briquettes and geo-polymer bricks or pavers as claimed in claim 1, wherein pulverizing by inter particle collision pulverizer that cuts the dry combustible MSW further into finer particles performing moisture separating, heat exchanging and dust collecting.

5. A novel method in converting all municipal solid waste into geo-polymer pellets or briquettes and geo-polymer bricks or pavers as claimed in claim 1, wherein de-volatizing and carbonization of combustible MSW is done by passing them through five stage reactor in which four stage step by step heating of the combustible MSW takes place by thermic fluid heat increasing process from 50 Degree Celsius at the first stage to 300 degree in the fourth stage ensuring carbonization and controlled removal of volatile gases.

6. A novel method in converting all municipal solid waste into geo-polymer pellets or briquettes and geo-polymer bricks or pavers as claimed in claim 1, wherein the cooling of combustible MSW is done at fifth stage of the five stage reactor by a single stage cooling system at the bottom intensifying the density of carbon molecules by de-volatizing carbonization process converting the combustible MSW into high calorific value fuel, reducing moisture and removing of volatile gases.

7. A novel method in converting all municipal solid waste into geo-polymer pellets or briquettes and geo-polymer bricks or pavers as claimed in claim 1, wherein an inter particle collision crusher which has both stationary sharp blades and flat moving blades moving at high speed creating centrifugal force crushes the non-combustible MSW repeatedly and it gets sheared and converted into powder form during which process the heat generated and the moisture is removed through a moisture separating, heat exchanging, dust collecting cyclone system.

8. An apparatus for carrying out the method in converting all municipal solid waste into pellets and geo-polymer briquettes and geo-polymer bricks comprising
i. a conveyor belt for moving the unsorted MSW from the dump yard onto a ramp and made to pass through a bag opener;
ii. a bag opener and crusher for opening household bags containing unsorted MSW to compress the unbreakable and break the breakable components and for crushing and squeezing to remove liquid content;
iii. a magnetic separator for removing ferrous things and eddy current separator for non-ferrous things from MSW before being put into a trommel;
iv. a trommel for separation into substantially combustible and non-combustible MSW through size separation;
v. inter particle collision drier, inter particle collision pulverizer and de-volatizing and carbonizing reactors to make combustible MSW into combustible high caloric value pellets or briquettes;
vi. Inter particle collision crusher and pan mixer to crush the non-Combustible MSW and a brick/paver molding plant to make into bricks and paver blocks;

9. An apparatus for carrying out the method in converting all municipal solid waste into geo-polymer pellets or briquettes and geo-polymer bricks or pavers as claimed in claim 8 wherein, the trommel is for size separation and inter particle collision crusher and pan mixer, moulder and drier to process the non-combustible MSW with addition of quarry dust/chips and fly ash to add strength and geo-polymer agents for inseparable bonding using geo polymerization process.

10. An apparatus for carrying out the method in converting all municipal solid waste into geo-polymer pellets or briquettes and geo-polymer bricks or pavers as claimed in claim 8 wherein, the trommel is for size separation and inter particle collision crusher and pan mixer, moulder and drier are meant to process the non-combustible MSW consisting of materials like glass, stone, mud and debris are crushed and pulverized and mixed with china clay/fly ash, quarry dust/chips, river sand, cement and molded into fly ash bricks and fly ash paver blocks.

11. An apparatus for carrying out the method in converting all municipal solid waste into geo-polymer pellets or briquettes and geo-polymer bricks or pavers as claimed in claim 8 wherein, the bag opener has spikes in the bag opener for piercing and shearing the household bags containing unsorted MSW and twin stage serrated double rolling drum crushers for letting unsorted MSW into the wedge between the concurrently rolling two stage double drum crusher with serrated ridges tangential to the axis of rotation of the crusher drum in the first stage and serrated ridges perpendicular to the axis of rotation of the crusher drum in the second stage in order to avoid slipping of material and increases the efficiency of the crusher, with heavy colliding springs crushing the breakable items such as building materials into finer particles and squeezing unbreakable items such as food waste and plastic. And simultaneously removing 50% of liquid content of unsorted MSW and delivering it to an effluent treatment plant.

12. An apparatus for carrying out the method in converting all municipal solid waste into geo-polymer pellets or briquettes and geo-polymer bricks or pavers as claimed in claim 8 wherein, the fluid extractive compressor which has a top end inlet for combustible MSW to be put inside and an outlet placed at the bottom for compressed combustible MSW to pass through which completes one cycle of compression and retraction every minute as two pistons moving against each other with heavy force for compressing and thereafter the front end piston retracting and back end piston pushing the compressed combustible MSW instantaneously until it falls through outlet simultaneously letting liquid content to the effluent treatment plant.

13. An apparatus for carrying out the method in converting all municipal solid waste into geo-polymer pellets or briquettes and geo-polymer bricks or pavers as claimed in claim 8 wherein, inter particle collision drier top shutter and bottom shutter which are in turn operated by a PLC controlled hydraulic system and which contains an inlet for making the 5 MM shredded Combustible MSW to go through a drying process due to heat generated by collision of inter particles due to their rotation of flat blades mounted on a rotating shaft across the stationary flat blades mounted on the walls, of the drum shaped drier being rotated at high speed resulting in heat generation and drying, while an inbuilt moisture absorber sucks the moisture through a moisture separating, heat exchanging, dust collecting cyclone system leaving Combustible MSW dry.

14. An apparatus for carrying out the method in converting all municipal solid waste into geo-polymer pellets or briquettes and geo-polymer bricks or pavers as claimed in claim 8 wherein, the inter particle collision pulverizer provided with an input feeding and output discharging screw conveyor and which has sharp moving as well as sharp stationary blades of unique shape of sickle devices to cut the dry combustible MSW further into finer particles for moisture separating, heat exchanging dust collecting cyclone system.

15. An apparatus for carrying out the method in converting all municipal solid waste into geo-polymer pellets or briquettes and geo-polymer bricks as claimed in claim 8 wherein de-volatizing and carbonization of combustible MSW is done by passing them through five stage reactor (of which the last stage is cooling stage) that heats up the combustible MSW step by step in four stages by thermic fluid heat increasing process from 50 Degree Celsius at the first stage to 300 degree in the fourth stage ensuring carbonization and controlled removal of volatile gases.

16. An apparatus for carrying out the method in converting all municipal solid waste into geo-polymer pellets or briquettes and geo-polymer bricks or paver blocks as claimed in claim 8, wherein the combustible MSW powder passed into the first cylinder of five stage de-volatizing carbonization reactor where the moisture is removed due to the heating of dry powdered combustible MSW by hot thermic fluid jacket surrounding the cylinder. This vaporizes the moisture content from the particle which is in turn removed by dust collecting moisture extracting cyclonic system fitted with heat exchanger.

17. An apparatus for carrying out the method in converting all municipal solid waste into geo-polymer pellets and briquettes and geo-polymer bricks and pavers as claimed in claim 8 wherein, the inter particle collision crusher contains both stationary sharp blades and flat moving blades which move at high speed with centrifugal force due to which the non-combustible MSW repeatedly crushed and shredded and converted into powder form during which heat generates and removes moisture through a moisture separating, heat exchanging ,dust collecting cyclone system.

18. An apparatus for carrying out the method in converting all municipal solid waste into geo-polymer pellets and briquettes and geo-polymer bricks and pavers as claimed in claim 8 wherein the moisture content is reduced by six stage moisture reduction processes at various levels by way of crushing, shredding, fluid extracting, drying, pulverizing and devolatizing carbonization reactor.

19. A bag opener with twin stage double rolling drum crushers provided with the spikes for shearing the household bags containing unsorted MSW and letting unsorted MSW into the wedge between the concurrently rolling two stage double drum crusher with heavy colliding springs crushing and removing about 50% of liquid content of unsorted MSW.

20. A fluid extractive compressor having a top end inlet for putting inside combustible MSW and an outlet placed at the bottom for passing the compressed combustible MSW which completes one cycle compression and retraction every minute as two pistons moving against each other with heavy force for compressing and thereafter the front end piston retracting and back end piston pushing the compressed Combustible MSW instantaneously until the compressed Combustible MSW falls through outlet simultaneously letting liquid content to the effluent treatment plant.

21. An inter particle collision drier containing an inlet for 5 MM shredded combustible MSW to go through a drying process due to heat generated by collision of inter particles due to their rotation caused by flat blades mounted on a rotating shaft across the stationary flat blades mounted on the walls, of the drum shaped drier being rotated at high speed resulting in heat generation and drying, while an inbuilt moisture absorber sucks the moisture through a moisture separating, heat exchanging, dust collecting cyclone system leaving Combustible MSW dry.

22. An inter particle collision pulverizer with provision for input feeding and output exit conveyor and which has sharp moving and stationary blades of unique shape of sickle devices that cuts the dry Combustible MSW further into finer particles having moisture separating, heat exchanging, dust collecting cyclone system.

23. An de-volatizing and carbonizing reactor having on its top an inlet for the dry combustible MSW to pass through five stage reactor that heats up the Combustible MSW in four stages through step by step by thermic fluid heat increasing process from 50 Degree Celsius at the first stage to 300 degree in the fourth stage ensuring carbonization and controlled removal of volatile gases and the fifth stage being a single stage cooling system at the bottom to intensify the density of carbon molecules after the de-volatizing carbonization process involving the conversion of combustible MSW into high calorific value fuel, reduction of moisture and maximum removal of volatile gases.

24. An inter particle collision crusher comprising both stationary sharp blades and flat moving blades which move at high speed with centrifugal force due to which the non-combustible MSW repeatedly crushed and sheared and converted into powder form during which heat generates and removes moisture through a moisture separating, heat exchanging, dust collecting cyclone system.
